(19) United States
(12) Patent Application Publication
(10) Pub. No.: US 2014/0347169 A1
(43) Pub. Date: Nov. 27, 2014

(54) SYSTEM FOR CONTROLLING AND SHOWING ELIGIBILITY OF GOLF PLAYERS ON A GOLF COURSE

(71) Applicant: Sportident International AB, Danderyd (SE)

(72) Inventors: Jan Olov Olsson, Taby (SE); Lars Linde, Taby (SE); Gunnar Larsson, Hoor (SE)

(21) Appl. No.: 14/360,572

(22) PCT Filed: Nov. 28, 2012
(86) PCT No.: PCT/SE2012/051317

§ 371 Date: May 23, 2014

Related U.S. Application Data
(60) Provisional application No. 61/563,876, filed on Nov. 28, 2011.

(51) Int. Cl. A63B 71/06; G06K 7/10; G08B 5/36; A63B 57/00

(52) U.S. Cl. CPC A63B 71/06; A63B 57/0081; G06K 7/10009; G08B 5/36
USPC 340/10.31

(57) ABSTRACT

The present invention relates to a system for golf score registration comprising a terminal at the clubhouse, and/or a start box at first tee, for check in and check out into the system before and after a game of golf, boxes (1) after each hole for score registration, means for communication between boxes on the course and a central unit, and individual information carriers that each player bring on to the course while playing. Each information carrier holds a flag indicating if the player bringing the information carrier is entitled to play on the golf course or not, and each box (1) is adapted to read the flag and thereby to determine the eligibility of a player holding an information carrier. Indicators (31, 32, 33, 34) positioned nearby each box (1) is adapted to indicate whether a player is eligible to play or not according to the determination.

### CROSS-REFERENCE TO RELATED PATENT APPLICATIONS

This application claims the benefit of priority of International Application No. PCT/SE2012/051317, filed on Nov. 28, 2012, which claims the benefit of priority of U.S. Provisional Application No. 61/563,876, filed on Nov. 28, 2011, both of which are hereby incorporated by reference in their entireties.

### FIELD OF INVENTION

The present invention relates to control of the eligibility of players playing on a golf course with a computerized system for golf score registration.

### DESCRIPTION OF BACKGROUND ART

It is previously known that when a person wants to play a game of golf he has to be allowed to enter the golf course. You are allowed playing on a golf course if for example you are a member and has paid the stipulated yearly fees, or you are a guest and has paid the green fee, the charge levied to play the course.

It is known to use a computerized system for score registration based on a terminal at the clubhouse, and/or a startbox at first tee, for check in and check out into the system before and after a game of golf, and boxes after each hole for score registration, where each player bring individual information carriers with a memory device, such as a chip, and where the boxes have readers to communicate with the information carriers and thereby enable the players to register scores from the game. It is also known to have an application for a smartphone, which enables the smartphone to be the information carrier through which the player can communicate with the system to register scores from the game. An example of such golf score registration system can be found in publication WO 2012/158104.

### SUMMARY OF THE PRESENT INVENTION

There is a problem today with persons playing on golf courses without paying the stipulated fees described above. The problem with not eligible playing has increased in recent years.

With the purpose of solving one or several of the above mentioned problems, and on the basis of the indicated field of invention and the background art as it has been shown above, the present invention provide ways of controlling players on a golf course, and to see if they are entitled to play on the golf course, via a computerized system for score registration.

The player carries information in his information carrier that he is allowed to play. While punching the chip at the boxes on the course, or via registration in the smartphone application, the system indicates if the player is entitled to play or not.

The control if players are eligible to play on the course is performed in such a way that people in the surrounding area can see if a person standing at the tee is entitled to play on the course or not by visual indications at the preceding box, the computerized system, smartphone applications and/or internal-TV.

The advantages that foremost may be associated with a system according to the present invention are that it provides a technical solution to the problem indicating if players playing a golf game has paid the fee for playing or not. The indication can be made clear to all other players on the golf course and to golf course personnel. The indication can also be made through any computer connected to the system or internal-TV.

### BRIEF DESCRIPTION OF THE DRAWINGS

A system according to the present invention will now be described in detail with reference to the accompanying drawings, in which:

FIG. 1 shows a schematic and simplified illustration of an inventive system, and

FIGS. 2a, 2b, 2c and 2d shows different proposed embodiments of indicators for indicating the eligibility of a player.

### DESCRIPTION OF EMBODIMENTS

The present invention will now be described with basic components in the system for a first proposed embodiment with an information carrier, also referred to as chip or microchip, and equipment for reading the information carrier, also referred to as box with readers, and for a second proposed embodiment an application software for smartphones where the smartphone is the information carrier.

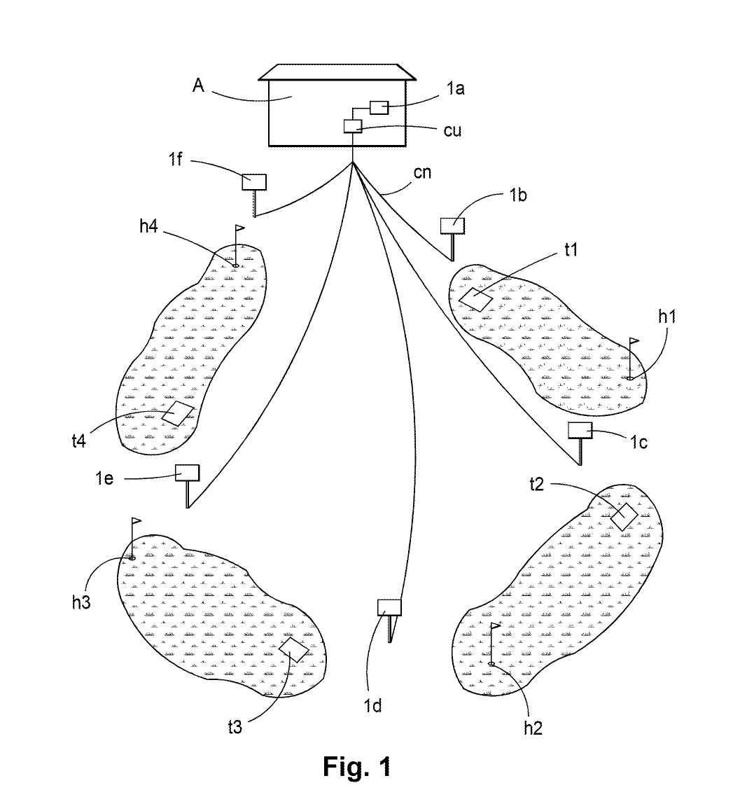

FIG. 1 shows the components in the score registration system that makes the control of players possible, the system comprising:
a terminal 1a at the clubhouse A for check in and check out into the system before and after a game of golf,
a start box 1b at first tee t1,
boxes 1c, 1d, 1e, 1f after each hole h1, h2, h3, h4 for score registration, and
a communication network cn between boxes 1b, 1c, 1d, 1e, 1f on the course and a central unit cu.

There may also be a possibility to integrate the system with a central national handicapping system for automatic handicap adjustments.

The system also comprises, or interacts with, individual information carriers (not shown in the figures) that each player bring on to the course while playing.

There are different ways to register scores in a system as described above, the present invention does not relate to the actual registration system; hence the registration system is not described in more detail than this.

There are also many ways of establishing communication between boxes and the central unit, and communication between the individual information carrier and the different boxes, and even if the present invention is dependent on such communication it is not described how it is performed since it can be established in many different ways and the skilled person can implement the present invention while using different available ways for communication between central unit and boxes, and between personal information carriers and boxes.

According to one proposed embodiment the control process is performed as described below.

Guests have to pay green fee in the clubhouse A and receive a temporary information carrier for the actual round. Members already have an own individual information carrier received and activated as they pay their first membership fee and then activated again when they paid the yearly membership fee.

The player checks into the system, for example at the clubhouse terminal 1 a, with the microchip. This is equal to “registration of arrival” and is kept in a system database based on the player's golf id.

At this stage information is transferred into the information carrier, referred to as a “flag” in the information carrier, indicating that the player is allowed to play.

At the start box 1b, at first tee t1, players punch their chips and indicators show that they have paid their fees and are allowed to enter the course. In this way people in the surrounding area can see that the person standing at the tee is entitled to play on the course. When you see a player on the tee, who is preparing to hit his first shot on the hole, control can be made that indication is made. If no indication is made, he is not allowed to play.

After each hole h1, h2, h3, h4 the player registers his score in the box 1c, 1d, 1e, 1f, placed close to the next tee t2, t3, t4, and each punch activates an indicator which makes it possible for people in the surrounding area to see that the person standing at the tee is entitled to play the next hole.

The information can also be presented in a computer system, in smartphone applications as well as on internal-TV available for whom it may concern.

Indication can be made in different ways such as light in different colours, such as red lamp for a player who is not allowed to play and green lamp for a player allowed to play.

An indicator can be a lamp, a light emitting diode, a display, a physical flag or pole, or anything else that can be seen from a distance. Several indicators can be used in one position to show that several players are allowed to play where one indicator will be activated for each entitled player.

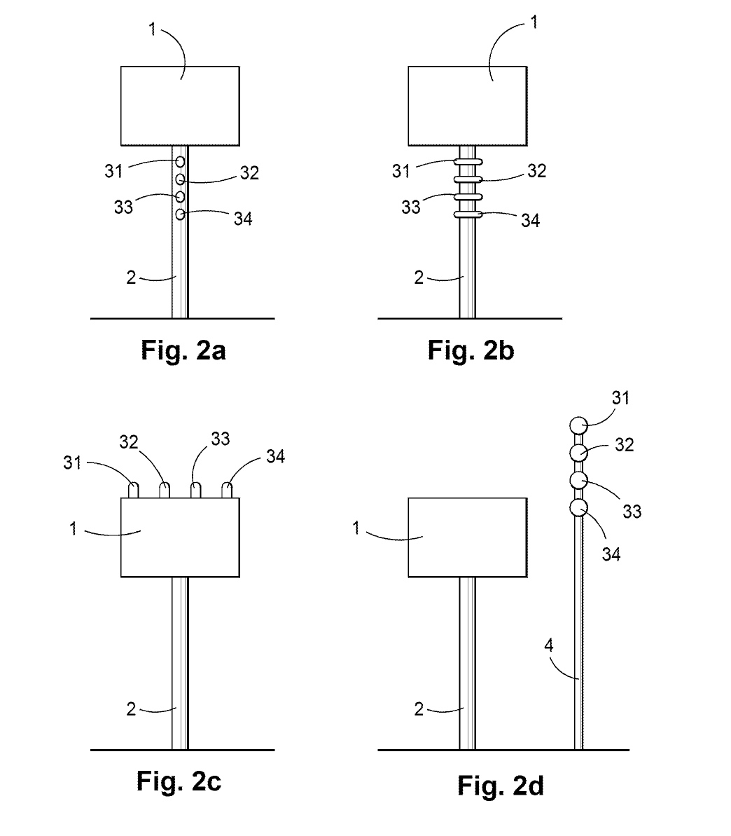

As shown in FIGS. 2a, 2b, 2c and 2d the indicators 31, 32, 33, 34 can for example be placed:
on the pole 2 holding the box 1 (FIG. 1a),
as rings around the box 1 or pole 2 visible from all angles and directions (FIG. 1b),
on the box 1 (FIG. 1c),
on top of a separate pole 4 close to the box 1 (FIG. 1d), or
any other way of mounting the indicators

It is proposed that upon check-in at the terminal information is sent to the boxes on the course that the player is entitled to play and the indicator can be activated when the player punch at the box.

It is also proposed that the indicators can be active all the time at the pole, for instance showing red, and that every time entitled players punch the indicators turns into another colour, such as green, or is turned off.

It is also proposed that the system comprises sensors at the tee box corners recognizing that a player is approaching and indicates with red or green on the pole depending on if the player is allowed to play or not, the tee box being a rectangular area from which players hit their first shot at each hole.

As an example the figures show four indicators; however it should be understood that the invention is not limited to the number of indicators and that any number of indicators can be used to enable the indication of any number of eligible players in one group of players approaching the tee.

According to another proposed embodiment a smartphone with an application software is used showing, via coordinates around the tee box, the area for tee shots on each hole. When a player enters the area the application software recognize the player and send his position and golf id to a server. The server informs personnel on the course that this player is approved by checking his golf id against membership file and file for arrival registrations.

According to one proposed embodiment the control process is performed as described below.

Guests pay green fee in the clubhouse and receive a receipt message in the smartphone application that they are approved to play the actual round. The same is valid for VIP's who don't have to pay anything. Members already have this info in their own individual smartphone applications received and activated when they paid the yearly membership fee.

The player checks into the system in the smartphone application, this is equal to “registration of arrival” and is kept in a system database based on the player's golf id.

At this stage information is transferred into the smartphone application, referred to as a “flag”, indicating that the player is allowed to play.

At the start box, at first tee, the player sends a message from their smartphone application asking for permission to start the round.

A message is returned from the system to the smartphone application and/or to the box with an approval to start or not. This can be presented in the smartphone application and/or via indicators in the tee box area. In this way people in the surrounding area can see if the person standing at the tee is entitled to play on the course or not. The information may also be presented in the computer system, in smartphone applications as well as on internal-TV available for whom it may concern.

After each hole the player registers his score in the smartphone application and each registration makes it possible for people in the surrounding area, in the same way as described above, to see that the person standing at the tee is entitled to play the next hole.

The possibility to indicate that you as a player is allowed to play can, as an option, be limited to presence in the tee box area.

Indication on whether a player using a smartphone as information carrier is eligible to play or not can be made in the same way as described above where a chip is used as information carrier.

Regardless of what kind of information carrier is used, it is proposed that if a player is not allowed to play according to the control of entitlement a consequence could be that the box and/or smartphone application is programmed not to work.

Players are informed via available devices that they are not allowed to play.

It will be understood that the invention is not restricted to the aforedescribed and illustrated exemplifying embodiments thereof and that modifications can be made within the scope of the invention as defined by the accompanying Claims.

1. A system for golf score registration comprising; a terminal at a clubhouse, and/or a start box at first tee, for check in and check out into the system before and after a game of golf, boxes after each hole for score registration, means for communication between boxes on a golf course and a central unit, and individual information carriers that each player bring on to the course while playing, wherein each information carrier holds a flag indicating if the player bringing the information carrier is entitled to play on the golf course or not, that each box is adapted to read said flag and thereby to determine the eligibility of a player holding an information carrier, and wherein indicators positioned nearby each box are adapted to indicate whether a player is eligible to play or not according to said determination.

2. The system according to claim 1, wherein the information carrier comprises a chip or microchip, and that said boxes are equipped to communicate with and read information from said information carrier.

3. The system according to claim 1, wherein the information carrier is a smartphone with an application software, and that said smartphone is adapted to communicate with said system or central unit.

4. The system according to claim 1, wherein information is transferred into said information carrier, the information transferred including setting said flag in the information carrier, and indicating that the player is allowed to play when an eligible player initiates a game at the start box or at first tee to be played.

5. The system according to claim 1, wherein eligibility information concerning a player is presented in a computer system, in smartphone applications and/or on internal-TV available for whom it may concern.

6. The system according to claim 1, wherein indication by the indicators is made through as light in different colors, such as red lamp for a player who is not allowed to play and green lamp for a player allowed to play.

7. The system according to claim 6, wherein the indicator is a lamp, a light emitting diode, a display, a physical flag or a pole, or anything else that can be seen from a distance.

8. The system according to claim 1, wherein several indicators are used in one position to show that several players are allowed to play, and that one indicator will be activated for each entitled player.

9. The system according to claim 1, wherein indicators are placed on a pole holding the box.

10. The system according to claim 9, wherein indicators are placed as rings around the box or pole visible from all angles and directions.

11. The system according to claim 1, wherein the indicators are placed on the box.

12. The system according to claim 1, wherein the indicators are placed on top of a separate pole close to the box.

13. The system according to claim 1, wherein upon check-in at the terminal information is sent to said boxes that the player is entitled to play and that the indicator is activated when the player punches at the box.

14. The system according to claim 1, wherein indicators are active all the time at a pole, for instance showing red, and that every time entitled a player punch said indicator turns into another color, such as green, or is turned off.

15. The system according to claim 1, wherein the system comprises sensors at tee box corners recognizing that a player is approaching, and that it is indicated on said indicators if the player is allowed to play or not.

16. The system according to claim 3, wherein the player checks into the system in said smartphone application.

17. The system according to claim 16, wherein the application software is used for showing, via coordinates around a tee box, an area for tee shots on each hole, that when a player enters the area the application software recognizes the player and sends his position and golf id to a server, and that said server informs personnel on the course that this player is approved by checking his golf id against a membership file and a file for arrival registrations.

18. The system according to claim 17, wherein the player sends a message from their smartphone application asking for permission to start the round at the start box or at a first tee to be played, and that a message is returned from the system to the smartphone application and/or to the box with an approval to start or not.

19. The system according to claim 18, wherein the message of approval is presented in the smartphone application and/or via indicators in a tee box area.

20. The system according to claim 18, wherein said message of approval information may also be presented in a computer system, in smartphone applications and/or on internal-TV available for whom it may concern.

21. The system according to claim 16, wherein the player registers his score in the smartphone application after each hole and each registration makes it possible for people in a surrounding area to see that a person standing at a tee is entitled to play the next hole.

22. The system according to claim 1, wherein a possibility to indicate that you as a player is allowed to play is limited to presence in a tee box area.

23. The system according to claim 1, wherein the box is programmed not to work if a player is not allowed to play to control entitlement.

24. The system according to claim 3, wherein the smartphone application is programmed not to work if a player is not allowed to play to control entitlement.

25. The system according to claim 1, wherein a player is informed via available devices that he is not allowed to play if the player is not allowed to play to control entitlement.
